(19) United States
(12) Patent Application Publication
(10) Pub. No.: US 2016/0092649 A1
(43) Pub. Date: Mar. 31, 2016

(54) System and Method for Determining Drug Usage by Indication

(71) Applicant: IMS Health Incorporated, Danbury, CT (US)

(72) Inventors: Michel Denarie, Yardley, PA (US); Melissa Leonhauser, Langhorne, PA (US)

(21) Appl. No.: 14/501,422

(22) Filed: Sep. 30, 2014

(51) Int. Cl. G06F 19/00

(52) U.S. Cl. CPC G06F 19/3456; G06F 19/3406

(57) ABSTRACT

A computer-assisted method that includes: identifying practitioners affiliated with a non-retail facility; gathering longitudinal prescription scripts by the identified prescribing practitioners as well as medical claims submitted by the identified prescribing practitioners to insurance carriers; linking the medical claims submitted by the identified practitioners to the longitudinal prescription scripts; based on each linked medical claim and longitudinal prescription script, generating a record of using the prescription drug for the corresponding one or more indication; generating a distribution factor of using the prescription drug for each of the one or more indications by the identified practitioners outside the non-retail facility; receiving information showing a volume of the prescription drug sold to the non-retail facility; and generating usage data by indications of the prescription drug for the non-retail facility by applying the generated distribution factor to the received information showing the volume of the prescription drug sold to the non-retail facility.

### BACKGROUND

A prescription pharmaceutical can have more than one FDA-approved indication, each intended to treat a different disease.

### OVERVIEW

In one aspect, some implementations provide a computer-implemented method for generating usage data of a prescription drug for one or more indications, the method including: identifying practitioners affiliated with a non-retail facility; gathering longitudinal prescription scripts written by the identified prescribing practitioners as well as medical claims submitted by the identified prescribing practitioners to insurance carriers, wherein each prescription script includes information representing a unique patient identifier that does not reveal the identity of the patient, a prescribed drug, and a prescribing practitioner; wherein each medical claim includes information representing a unique patient identifier that does not reveal the identity of the patient, an office visit, a rendering practitioner, and at least one indication; linking the medical claims submitted by the identified practitioners to the longitudinal prescription scripts at least in part based on a matching unique patient identifier that does not reveal the identity of the patient; based on each linked medical claim and longitudinal prescription script, generating a record of using the prescription drug for the corresponding one or more indication by the matching practitioner in an office visit outside the non-retail facility; generating a distribution factor of using the prescription drug for each of the one or more indications by the identified practitioners outside the non-retail facility; receiving information showing a volume of the prescription drug sold to the non-retail facility; and generating usage data for each of the one or more indications of the prescription drug for the non-retail facility by applying the generated distribution factor of using the prescription drug for each of the indications by the identified physicians outside the non-retail facility to the received information showing the volume of the prescription drug sold to the non-retail facility.

Implementations may include one or more of the following features. Some implementations may further include: generating the distribution factor that shows a distribution of usage among the one or more indications of the prescription drug. The implementations may further include applying the generated distribution factor by weighing the prescription patterns of the identified physicians outside the non-retail facility. In these implementations, the weighing includes consolidating individual distributions of the identified physicians outside the non-retail facility according to the respective prescription volume of the identified physicians outside the non-retail facility. In these implementations, consolidating individual distributions of the identified physicians outside the non-retail facility may further account for the respective ratio of time allocation by each of the identified physicians outside the non-retail facility and inside the non-retail facility.

Some implementations may further include: identifying practitioners in a zip code; gathering longitudinal prescription scripts written by the identified practitioners and filled at retail stores in the zip code as well as medical claims submitted by the identified practitioners to insurance carriers; linking the medical claims to the longitudinal prescription scripts at least in part based on a matching unique patient identifier that does not reveal the identity of the patient; compiling usage data by indications of the prescription drug for each of the one or more indications from retail stores in the zip code. The implementations may further include combining usage data by indications of the prescription drug for a particular indication from retail stores and usage data by indications of the same prescription drug for the same indication from non-retail facilities. The implementations may additionally include: generating the combined usage data over a sliding window of time. In these implementations, the sliding window of time spans over a period immediately preceding a particular time point. These implementations may further include tracking the combined usage data over time. Example time window can be 6 months or longer.

Some implementations may further include: receiving data showing office visits for the particular indication, the office visits data referencing more than one prescription drug for treating the particular indication. The implementations may further include: calibrating the generated usage data by indications at the non-retail facility by: aggregating the generated usage data for the particular indication over the more than one prescription drug; and comparing the aggregated usage data for the particular indication with office visit data at the non-retail facility for the particular indication.

Some implementations may further include: receiving consumption data by a particular indication from a reporting facility that combines contributions from the more than one prescription drug and from non-retail facilities in one or more jurisdictions. These implementations may further include receiving consumption data by the particular indication from the reporting facility that combines contributions from the more than one prescription drug and from non-retail facilities national wide. These implementations may additionally include: calibrating the generated usage data by indications at the non-retail facility by aggregating the generated usage data by the particular indication over the more than one prescription drug and from non-retail facilities in the one or more jurisdictions; and comparing the aggregated usage data to the received consumption data from the one or more jurisdictions.

In some implementations, linking the medical claims to the longitudinal prescription scripts may further include: linking the medical claims to the longitudinal prescription scripts with a matching anonymized patient ID, practitioner or a matching office visit.

In some implementations, the non-retail facility includes a hospital, a clinic, or a long-term care facility. In these implementations, the long-term care facility may include a rehabilitation facility, a nursing facility, an in-patient mental health facility, or an in-patient chronic care facility.

In some implementations, each medical claim may further include information representing an office visit date and a drug dispensed by the rendering physician.

The details of one or more aspects of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a diagram illustrating obtaining the retail channel usage of a drug by indication in one zip code.

FIG. 2A is a flow chart showing a process to obtain non-retail channel usage of a drug by indication.

FIG. 2B illustrates identifying physicians affiliated with a non-retail facility.

FIG. 2C illustrates generating an indication factor based on usage of the drug by indication by the affiliated physicians and applying the factor to sales data at the non-retail facility.

FIG. 2D illustrates calibrating the imputed drug usage by indication at the non-retail facility by aggregating over more than one drug.

FIG. 2E illustrates calibrating the imputed drug usage by indication by aggregating over more than one drug and over one or more jurisdictions for a variety of indications.

Like reference symbols in the various drawings indicate like elements.

### DETAILED DESCRIPTION

This disclosure generally describes a system and method for reporting a prescription drug usage by indication from both retail and non-retail channels. The retail channels may include general pharmacies as well as specialty pharmacies. The non-retail channels may include hospitals, rehabilitation clinics, physical therapy facilities, out-patient treatment facilities, as well senior retirement facilities. A pharmaceutical prescription drug as approved by a regulatory agency may have more than one indication for therapeutic efficacy. While the sales number at retail channels and non-retail channels can be readily tracked, such sales number may not reflect the actual usage of a particular drug for a particular indication. In comparison, systems and methods disclosed herein may provide usage data of the particular prescription drug for the particular indication arising from both retail and non-retail channels.

A prescription pharmaceutical may have more than one indication for therapeutic treatment. Here, a prescription pharmaceutical may refer to a prescription drug. As an illustration, the prescription pharmaceutical may be initially approved by a regulatory agency (such as the Federal Drug Administration) for one use and subsequently approved for other uses through secondary indications. By way of illustration, Botox® (Botulinum toxin) was initially approved in 2002 for the improving the appearance of moderate-to-severe frown lines between the eyebrows (glabellar lines). After the initial approval, the drug was approved for treating chronic migraine pain in 2010. Specifically, this indication is for improving headache symptoms and quality of life for chronic migraine patients who exhibit headache characteristics consistent with: pressure perceived from outside source, shorter total duration of chronic migraines (<30 years), “detoxification” patients with coexisting chronic daily headache due to medication overuse, and no current history of other preventive headache medications. More recently, the drug has been approved for treating incontinence due to overactive bladder. In summary, a prescription pharmaceutical such as a prescription drug can have more than one indication. As a result, the same prescription pharmaceutical can be used for each of the multiple indications. Track the individual use for the particular indications can provide actionable intelligence to decision makers.

While the entire sales data for the prescription pharmaceutical may be available from sales activities, the usage for each of the multiple indications may need more detailed analysis and can provide more insight into how the prescription drug is being used for treatments. In one example, the absolute usage data in each indication may provide guidance to manufacturing activities. In another example, the relative usage data for all the indications may reveal the distributive use of the usage. In other examples, the trending data of usage in each indication can lead to regression or correlation analytics to better understand the dynamics of drug usage. In one instance, the uptake of a new indication for an already approved prescription drug may be tracked at launch. In another instance, the market share of the new indication after launch can be tracked over time. In yet another instance, when patients use the same prescription drug for a different indication, trending analysis may be performed to reveal the trend. Likewise, when patients use the a different prescription drug for the same indication, the trend may be analyzed to shed further light on the usage of the prescriptions drugs. The improved intelligence can motivate those who distribute the medication to monitor the use of the drug (e.g., to reduce risks) and help the pharmaceutical manufacturer track inventory. The more fine-grained analysis may provide teams for different indications of the same drug with actionable intelligence with regard to actual usage in each indication.

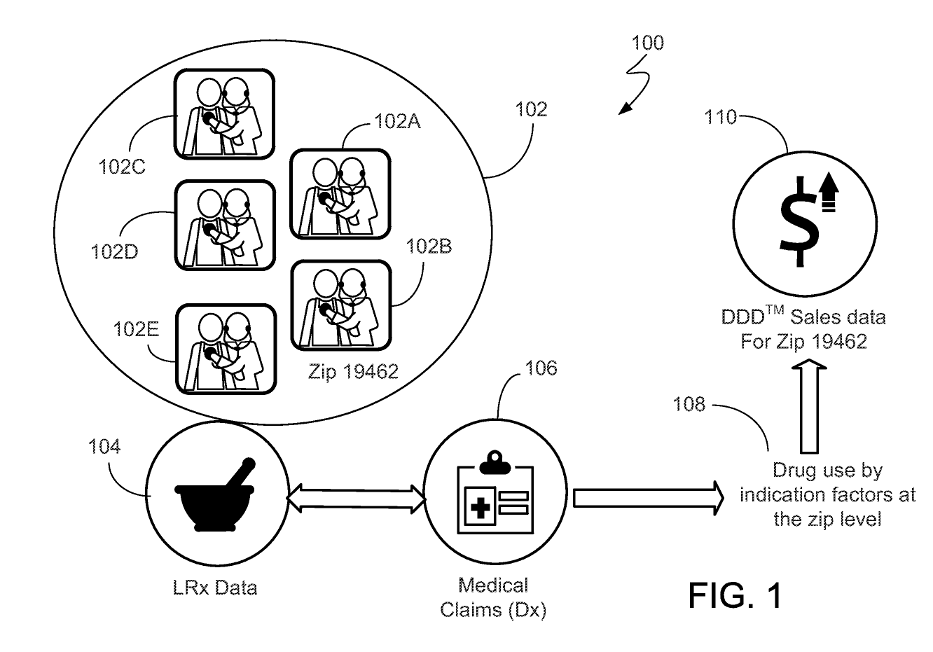

FIG. 1 is a diagram 100 illustrating obtaining the retail channel usage of a drug by indication in one zip code. Retail channel refers to general pharmacies or specialty pharmacies in the business of filling prescriptions for patients and reporting the same. Initially, the practitioners 102 in a zip code may be identified. In one implementation, practitioners 102A to 102E may be identified as licensed medical doctors with a prescribing office in the zip code. In other implementations, practitioners 102A to 102E may include persons with authority to prescribe medications within the zip code. Such persons may generally include advanced practice nurses, dentists, optometrists, physicians, physician assistants, podiatrists, or veterinarians.

Once such prescribing practitioners within the zip codes are identified, the longitudinal prescription data can be gathered from the prescription written by these prescribers (104). The longitudinal prescription data may be stored in a database in an anonymized fashion. For example, such data is de-identified to comply with, for example HIPPA (Health Insurance Portability and Accountability Act) regulations to protect the privacy and confidentially of the patient. The de-identification may generally cause the record not to disclose the identity of the patient. De-identification may generally incorporate encryption (e.g., two way symmetric encryption) and hashing (e.g., one-way transform). In some implementations, the identity of the prescribing practitioner may also be concealed to maintain confidentiality and privacy of the practitioners. The prescription data may include a longitudinal aspect such that prescriptions of a particular drug for a given indication for the same patient can be tracked over time, for example, after the prescription scripts are linked to diagnostic claims. Likewise, the prescription of a particular drug for a given indication by a specified prescribing practitioner may also be tracked over time. When the prescriptions are filled or refilled at pharmacies, the prescribed drug may be used for the particular indication as prescribed. The prescriptions of drugs as filled at retail pharmacies for various indications may thus be analyzed and tracked.

In the meantime, medical claims 106 regarding an office visit in which a prescription may have been provided for the particular indication may be submitted. In the medical claim, the indications (for example, an ICD9 code) or the procedures (e.g., CPT codes) may be mentioned. In particular, if the doctor prescribed a drug to be filled at the pharmacy, the prescription script generally will not show on the medical claim. In some instances, for example, when the doctor dispenses the drug in the office (e.g., applying Botox), then both the prescription drug and the indication may be present on the medical claim. Some implementations may link the medical claims 106 with the longitudinal prescription data 104. In some cases, the linking may be performed by a matching patient identifier that does not reveal the identity of the patient. In some cases, the linking may further include matching prescribing practitioner's identification number (or an internal reference number when the identity of the prescribing practitioner has been concealed). In some cases, the linking may be enhanced by a matching office visit date or matching office address (e.g., matching zip codes).

In still other cases, the linking may be extended to account for the same patient seeking treatment for the same condition. For example, the patient may not show any signs of response to a prescription drug as prescribed at one dose for a particular indication. The same prescribing practitioner may prescribe the same drug later at an elevated dose. In another example, the patient may overreact to the drug prescribed at the initial dosage and the same prescribing practitioner may reduce the dosage in a later prescription. Similarly, in the above cases, the prescribing practitioner may be switched to a different but comparable drug to alleviate the issues of no reaction, over reaction, or adverse effects, or if the test results show that the patient is not at the desired therapeutic goal (e.g. cholesterol levels reduction has not been achieved).

Likewise, in the above cases, the patient may switch from one practitioner to another when seeking a plain refill or a new prescription with less than satisfactory results.

In a similar vein, the same patient, when receiving treatment for a particular condition, can switch insurance carriers. A healthcare insurance carrier may include any private insurance companies, for example, blue cross blue shield, MetLife, Delta, etc. The healthcare insurance carrier may also include any government-run healthcare programs, including Medicare, Medicaid, Medi-Cal, etc. By way of illustration, the patient can switch from BCBS of Maryland to Coventry, as a new healthcare insurance carrier. Extended linking may connect prescriptions for the same patient and treating the same condition, even though the prescriptions may include subsequent optimization prescriptions from the same prescribing practitioner, subsequent prescriptions from a different practitioner, subsequent prescriptions claimed under the same insurance carrier, or subsequent prescriptions claimed under a different insurance carrier.

Once the medical claims 106 and longitudinal prescription data 104 are linked, actual usage data of a particular drug for a given indication within the zip code can be obtained. By comparing the drug usage data by indications with sales data for the drug sold in the zip code 110, drug usage by indication factors 108 may be generated for each zip code. Assuming the prescribing practitioners follow the same pattern for prescribing a drug for various indications, the drug usage by indication factors may be applied to non-retail channels (such as hospitals and clinics without a retail pharmacy) to elicit an estimate of the drug usage from the non-retail channels. Moreover, the drug usage data from both retail and non-retail channels can be aggregated over each zip code or over multiple jurisdictions and then calibrated against sales data.

Although the usage by indications may be obtained from retail channels (e.g., those filled at retail pharmacy stores), many drugs have indications that are likely administered through non-retail channels (e.g., hospitals, rehabilitation clinics, physical therapy facilities, as well senior retirement facilities). Usage data from the non-retail channels may not be subject to documented prescriptions scripts and thus may not be captured by the above analysis based on linkage between medical claims and prescription scripts. In some cases, the prescription drug may be used for an indication and administered in a hospital or out-patient center. By way of illustration, the prescription drug may be Remicade® with at least three indications, namely, rheumatoid arthritis (RA), Crohn's disease, and psoriatic arthritis or psoriasis. RA may be treated by a rheumatologist. Crohn's disease may be treated by a gastroenterologist. Psoriatic arthritis or psoriasis may be treated by a dermatologist. Moreover, the drug may be infused at a doctor's office or it can be infused at a hospital or an out-patient facility that includes an infusion center. Generally, rheumatologists have their own infusion suite and they can infuse the drug in their suites. Gastroenterologist and dermatologists, however, often do not have their own infusion suites and are more likely to refer their patients to an outpatient infusion center associated with a hospital or clinic, for example, to use an infusion center therein. Hence, for the same drug, some indications may often see dispensement in retail channels while others are more likely used through non-retail channels.

Notably, the linkage methodology described may not apply to usage data in the non-retail channels. For example, there can be no reported prescription for such infusion used in the same hospital/clinic. Similarly, there can be limited distribution drugs for various treatments through non-retail channels. For example, Sutent® can be prescribed for kidney cancer, gastrointestinal stromal tumor (GIST), and pancreatic neuroendocrine tumor (pNET) treatments through cancer treatment centers. More detailed analysis to reveal the usage of a drug in various indications can provide more insight for marketing, manufacturing, as well as regulatory initiatives. However, if a prescription drug is entirely used in non-retail channels such as a hospital or clinic, then the distribution of the prescription drug among various indications can be determined from the submitted claims alone, which indicate the one or more indications that the prescription drug is being prescribed for. The methodology below generally applies to situations when the prescription drug is used in both the retail and non-retail channels as well as used for multiple indications.

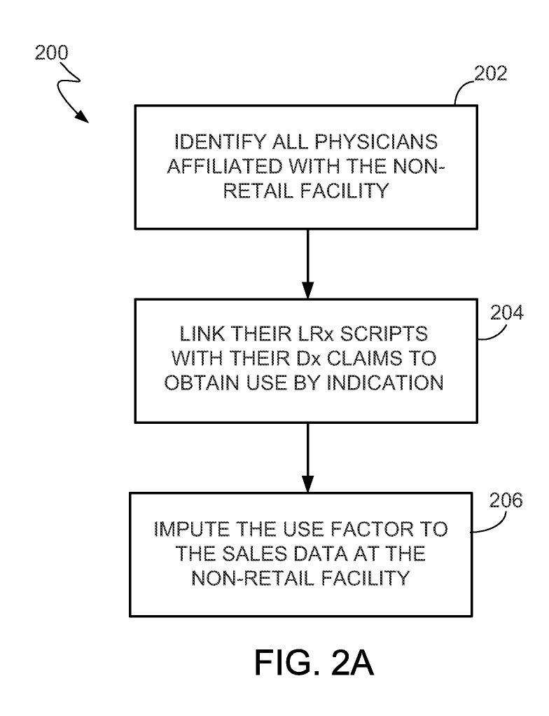

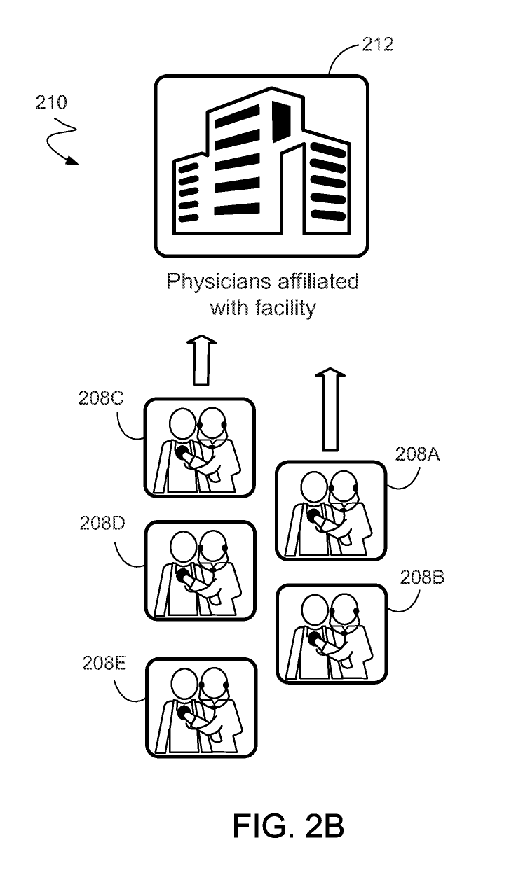

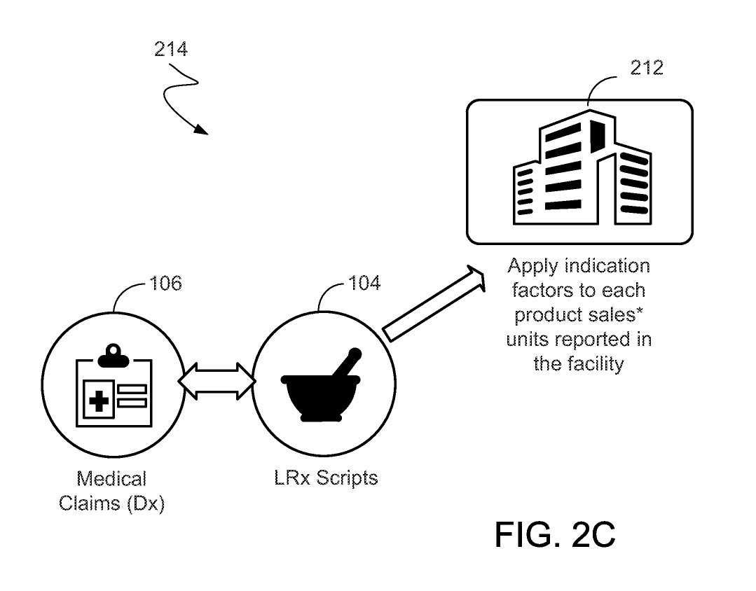

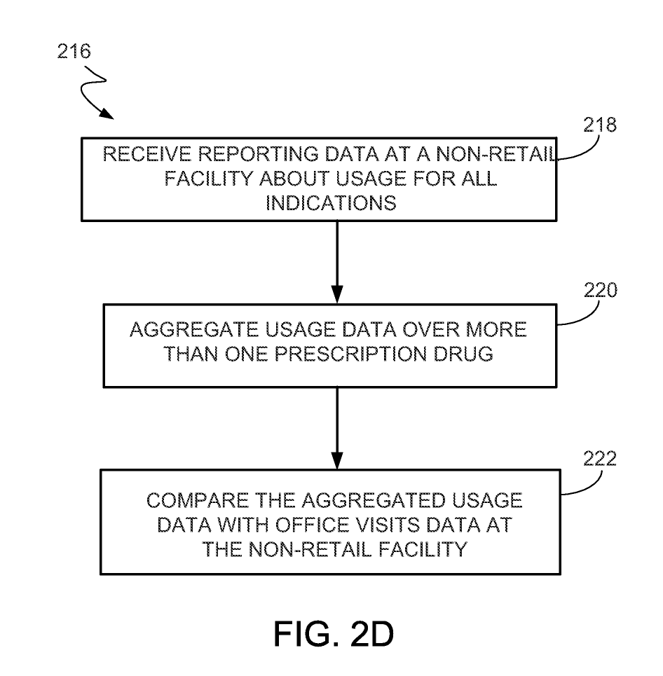

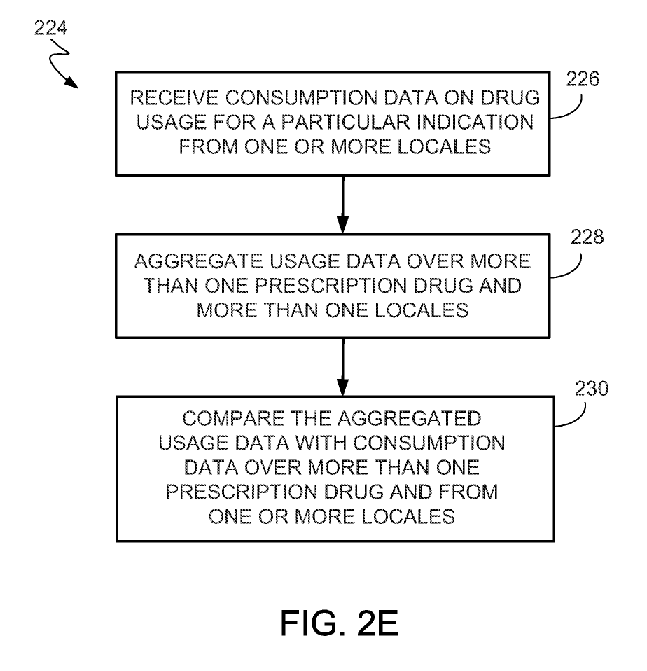

FIG. 2A is a flow chart 200 showing a process to obtain non-retail channel usage of a drug by indication. Initially, a non-retail channel is identified, along with the practitioners authorized to prescribe medications and affiliated with the non-retail channel (202). As noted, the non-retail chancel can include a particular hospital, a particular rehabilitation clinic, a particular physical therapy facility, a senior retirement facility, or an out-patient treatment facility. Affiliated prescribing practitioner may include advanced practice nurses, dentists, optometrists, physicians, physician assistants, podiatrists, or veterinarians. The affiliation may be corroborated by publications, such as a directory, by the identified non-retail channel, or publications by a third party, such as a listing through the relevant Board of Medical Practitioners. The affiliation may be manifested by virtue of the prescribing physician holding an appointment, seeing patients, or having an office at a hospital, in addition to having an office outside the hospital.

The method may then proceed to link the longitudinal prescription scripts of the affiliated practitioners with medical claims submitted by the affiliated practitioners to reconstruct the usage data for each indication of a particular drug (204). Some implementations may link the longitudinal prescription scripts to medical claims submitted by the same practitioners by virtue of, for example, matching patient information such as an ID (or an internal reference number). In some cases, the patient information (including the ID or the internal reference number) can be encrypted (e.g., via a two-way symmetric encryption) or hashing (e.g., by a one-way mapping function). The longitudinal prescription scripts may provide the name and strength (e.g., dose level and duration) of a prescribed drug. The longitudinal prescription scripts, however, may not provide usage of the drug for a particular indication. The medical claims, on the other hand, may provide the name and one or more indications of the prescribed drug. Linking the longitudinal prescription scripts with the medical claims may reconstruct a full picture of the prescribed drug being used for one or more indications by the affiliated prescribing practitioners in their practice through the retail channels. As noted above, the methodology of linking the longitudinal prescription scripts with the medical claims can reveal drug usage by indication when the prescription drug has been prescribed and then dispensed through retail channels, such as a general pharmacy or specialty pharmacy, or mail order.

The tracked data may provide a variety of opportunities for trending analysis. In one example, the trend of patients switching from one prescription pharmaceutical to another prescription pharmaceutical for the same indication may be captured and reported. In another example, the trending pattern of patients switching from one indication to another indication for the same prescription pharmaceutical may be captured and reported. In yet another example, the trend of patients switching from one dose level to an elevated (or reduced) dose level for the same prescription pharmaceutical and same indication may be captured and reported. Such trending pattern can provide additional insight to manufacturers, regulators, as well as prescribing practitioners about the use pattern of a particular prescription pharmaceutical.

In some implementations, after the drug usage by indication has been determined for the affiliated prescribing practitioners outside the organization forming the non-retail channel, the use factor (e.g., the distribution of drugs among the various indications) may be applied to the sale volume of the same prescription drug sold into the organization of the affiliated prescribing practitioners. The organization may refer to a facility such as a hospital, a clinic, an out-patient center, or a senior retirement community. In cases where the organization is affiliated with more than one prescribing practitioners, the distribution from the more than one prescribing practitioners may be weighted according to the respective volume of drugs prescribed by each of the prescribing practitioners outside the organization. In this manner, based on the volume of drug sold into the organization and the distribution ratio of various indications for the same drug, usage by indication by the affiliated prescribing practitioners outside the organization (such as a hospital) may be imputed to the drug usage by the organization. The imputation may further factor in known differences in the prescribing patterns of the affiliated practitioners practicing outside the organization and within the organization.

FIG. 2B is a diagram 210 illustrating identifying prescribing practitioners affiliated with a facility 212. The facility 212 may be part of the non-retail channels and may include hospitals, rehabilitation clinics, physical therapy facilities, out-patient treatment facilities, as well senior retirement facilities. Affiliated prescribing practitioner 208A to 208E may include advanced practice nurses, dentists, optometrists, physicians, physician assistants, podiatrists, or veterinarians. The affiliation may include the prescribing practitioner holding an appointment at facility 212, taking a financial compensation from facility 212, seeing patients at facility 212, or having an office at facility 212, in addition to having an office outside facility 212. The affiliation may be corroborated by publications, such as a directory, by the identified non-retail channel, or publications by a third party, such as a listing through the Board.

Turning to FIG. 2C, longitudinal prescription scripts 106 of the affiliated practitioners 208A to 208E with medical claims submitted by the same affiliated practitioners to reconstruct the usage data for each indication of a particular drug outside the facility 212. Some implementations may link the longitudinal prescription scripts to medical claims submitted by the same practitioners by virtue of, for example, matching patient information such as an ID (or an internal reference number or alpha numerical string). In some cases, the patient information (including the ID or the internal reference number or alpha numerical string) can be encrypted (e.g., by a two-way symmetric key) or hashed (e.g., for a one-way mapping function). The longitudinal prescription scripts may provide the name and strength (e.g., dose level and duration) of a prescribed drug. The longitudinal prescription scripts, however, may not provide usage of the drug for a particular indication. The medical claims, on the other hand, may provide the name and one or more indications of the prescribed drug. Linking the longitudinal prescription scripts with the medical claims may reconstruct the distribution usage of the prescribed drug among the one or more indications by the affiliated prescribing practitioners in their practice outside the affiliated facility 212.

When the prescription drug has multiple indications applicable in both non-retail channels and retail channels, the usage in the non-retail channel may not require reportable prescription scripts and hence medical claims submitted by the prescribing practitioners may not have corresponding reportable prescription scripts. In these situations, medical claims submitted by prescribing practitioners affiliated to facility 212, from their private office in the community, may be analyzed to determine the usage distribution among the various indications of a prescription drug based on the prescribing pattern of the same practitioners outside the affiliating facility 212.

As illustrated in diagram 214 of FIG. 2C, once the distribution usage for a particular prescription drug has been determined for the affiliated prescribing practitioners in their practice outside the affiliated facility 212, the distribution can be applied to the volume of the same prescription drug sold to facility 212. For context, the sale volume of the particular prescription drug can be determined from sales records. Assuming the prescribing practitioners would use the prescription drug in facility 212 in a manner analogous to how they use the same prescription drug outside facility 212, based on the volume of drug sold into facility 212 and the distribution ratio of various indications for the same prescription drug outside the facility 212, usage by indication by the affiliated prescribing practitioners outside facility 212 may be imputed to the drug usage by the same affiliated prescribing practitioners practicing inside facility 212. In cases where more than one prescribing practitioners are affiliated with facility 212, the distribution ratio from the more than one prescribing practitioners may be weighted according to the respective volume of drugs prescribed by each of the prescribing practitioners outside the facility. In some instances, the imputation can be a straightforward carryover (from the activity outside the hospital to the inferred activity in the hospital). In some instances, the imputation may further factor in known differences in the prescribing patterns of the affiliated practitioners practicing outside the facility 212 and within the facility 212. For example, if it is known that doctor A spends 40% of his time outside facility 212 while doctor B spends 60% of her time outside facility 212, their distribution ratio among the various indications outside facility 212 may be weighed accordingly during the imputation process.

Some implementations may further include a calibration mechanism to indicate the quality of usage data generated. In one example, the generated usage data for a particular indication at a non-retail facility can be correlated to office visits data for the same particular indication at the non-retail facility. As illustrated by diagram 224 of FIG. 2E, data showing office visits at the non-retail facility for the particular indication may be received initially (224). The office visits data may reference more than one prescription drug for treating the particular indication. The office visit data may be compiled for a particular non-retail facility, such as a hospital (228). The generated usage data for the particular indication at the non-retail facility may be aggregated over more than one prescriptions drug. The more than one prescription drug may be sold to the non-retail facility. The aggregated usage data for the particular indication at the non-retail facility may then be correlated with data showing office visits at the same non-retail facility regarding the particular indication (230). For calibration purposes, the aggregated usage data for the particular indication should be on par with the data showing office visits at the non-retail facility for the same particular indication. If the aggregated usage data deviates substantially from the office visits data, the deviation may flag a deficient quality in either the generated usage data or the office visits data as reported. In some instances, a calibration factor can be generated based on the deviation and then applied to existing data to reconcile the two.

In another example, the generated combined usage data for a particular drug for the one or more indications may be summed over one or more locales and then compared to data of dispensing the particular drug in these locales as a whole. A locale may refer to a zip code, a geographic region, a jurisdiction, etc. As illustrated by diagram 224 of FIG. 2E, initially the consumption data by a particular indication may be from a reporting facility (226). The consumption data may combine contributions from the more than one prescription drug and from non-retail facilities in one or more locales. In one illustration, the consumption data may combine contributions from the more than one prescription drug and from non-retail facilities at the national level. Here, the locale can refer to a municipal level, a town level, a city level, a state level, a national level, or even at a level of a group of countries (for example, under a treaty agreement). The generated usage data by the particular indication over the more than one prescription drug and from non-retail facilities in the one or more jurisdictions may be aggregated (228). Thereafter, the generated usage data aggregated over the one or more locales may be compared to the reported consumption data for these locales (230). For calibration purposes, the aggregated usage data for these locales should match the consumption data from these locales for the same indication of the same prescription drug. If the aggregated usage data deviates substantially from the reported consumption data, the deviation may flag a deficient quality in either the generated usage data or the reported consumption data.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method for generating usage data of a prescription drug for one or more indications, the method comprising:
identifying practitioners affiliated with a non-retail facility;
gathering longitudinal prescription scripts by the identified practitioners as well as medical claims submitted by the identified practitioners to insurance carriers,
wherein each prescription script includes information representing a unique patient identifier that does not reveal a patient's identity, and a prescribed drug;
wherein each medical claim includes information representing a unique patient identifier that does not reveal the patient's identity, and at least one indication;
linking the medical claims submitted by the identified practitioners to the longitudinal prescription scripts at least in part based on a matching unique patient identifier that does not reveal the patient's identity;
based on each linked medical claim and longitudinal prescription script, generating a record of using the prescription drug for the corresponding one or more indication by the matching practitioner outside the non-retail facility;
generating a distribution factor of using the prescription drug for each of the one or more indications by the identified practitioners outside the non-retail facility;
receiving information showing a volume of the prescription drug sold to the non-retail facility; and
generating usage data for each of the one or more indications of the prescription drug for the non-retail facility by applying the generated distribution factor of using the prescription drug for each of the indications by the identified physicians outside the non-retail facility to the received information showing the volume of the prescription drug sold to the non-retail facility.

2. The method of claim 1, further comprising:
generating the distribution factor that shows a distribution of usage among the one or more indications of the prescription drug.

3. The method of claim 2, further comprising:
applying the generated distribution factor by weighing the prescription patterns of the identified physicians outside the non-retail facility.

4. The method of claim 3, wherein the weighing includes consolidating individual distributions of the identified physicians outside the non-retail facility according to respective prescription volumes of the identified physicians outside the non-retail facility.

5. The method of claim 4, wherein consolidating individual distributions of the identified physicians outside the non-retail facility further accounts for a respective ratio of time allocation by each of the identified physicians outside the non-retail facility and inside the non-retail facility.

6. The method of claim 1, further comprising:
identifying practitioners in a locale;
gathering longitudinal prescription scripts by the identified practitioners filled at retail stores in the locale as well as medical claims submitted by the identified practitioners to insurance carriers;
linking the medical claims to the longitudinal prescription scripts at least in part based on a matching unique patient identifier that does not reveal the patient's identity;
compiling usage data for each of the one or more indications of the prescription drug in the locale.

7. The method of claim 6, wherein the locale is identified by a zip code.

8. The method of claim 6, further comprising:
combining usage data by indications of the prescription drug for a particular indication from retail stores and usage data by indications of the same prescription drug and the same indication from non-retail facilities.

9. The method of claim 8, further comprising:
generating the combined usage data over a sliding window of time.

10. The method of claim 9, wherein the sliding window of time spans over a period immediately preceding a particular time point.

11. The method of claim 8, further comprising:
tracking the combined usage data over time.

12. The method of claim 1, further comprising:
receiving data showing office visits at the non-retail facility for the particular indication, the office visits data referencing more than one prescription drug for treating the particular indication.

13. The method of claim 1, further comprising:
calibrating the generated usage data by indications at the non-retail facility by:
aggregating the generated usage data for the particular indication over the more than one prescription drug; and
comparing the aggregated usage data for the particular indication with office visit data at the non-retail facility for the particular indication.

14. The method of claim 1, further comprising:
receiving consumption data by a particular indication from a reporting facility that combines contributions from the more than one prescription drug and from non-retail facilities in one or more locales.

15. The method of claim 14, further comprising receiving consumption data by the particular indication from the reporting facility that combines contributions from the more than one prescription drug and from non-retail facilities at a national level.

16. The method of claim 14, further comprising:
calibrating the generated usage data by indications by:
aggregating the generated usage data by the particular indication over the more than one prescription drug and from non-retail facilities in the one or more jurisdictions; and
comparing the aggregated usage data to the received consumption data from the one or more jurisdictions.

17. The method of claim 1, wherein linking the medical claims to the longitudinal prescription scripts further comprises: linking the medical claims to the longitudinal prescription scripts with a matching practitioner or a matching office visit.

18. The method of claim 1, wherein the non-retail facility includes a hospital, a clinic, or a long-term care facility.

19. The method of claim 18, wherein the long-term care facility includes a rehabilitation facility, a nursing facility, an in-patient mental health facility, or an in-patient chronic care facility.

20. The method of claim 1, wherein each prescription script further includes information representing a prescribing practitioner, and wherein each medical claim further includes information representing an office visit date, a rendering physician, a drug dispensed by the rendering physician.

21. A computer comprising one or more processors, configured to perform the operations of:
identifying practitioners affiliated with a non-retail facility;
gathering longitudinal prescription scripts by the identified practitioners as well as medical claims submitted by the identified practitioners to insurance carriers,
wherein each prescription script includes information representing a unique patient identifier that does not reveal a patient's identity, and a prescribed drug;
wherein each medical claim includes information representing a unique patient identifier that does not reveal the patient's identity, and at least one indication;
linking the medical claims submitted by the identified practitioners to the longitudinal prescription scripts at least in part based on a matching unique patient identifier that does not reveal the patient's identity;
based on each linked medical claim and longitudinal prescription script, generating a record of using the prescription drug for the corresponding one or more indication by the matching practitioner outside the non-retail facility;
generating a distribution factor of using the prescription drug for each of the one or more indications by the identified practitioners outside the non-retail facility;
receiving information showing a volume of the prescription drug sold to the non-retail facility; and
generating usage data for each of the one or more indications of the prescription drug for the non-retail facility by applying the generated distribution factor of using the prescription drug for each of the indications by the identified physicians outside the non-retail facility to the received information showing the volume of the prescription drug sold to the non-retail facility.

22. A computer-readable medium, comprising software instructions, that when executed by a computer, cause the computer to execute the operations of:
identifying practitioners affiliated with a non-retail facility;
gathering longitudinal prescription scripts by the identified practitioners as well as medical claims submitted by the identified practitioners to insurance carriers,
wherein each prescription script includes information representing a unique patient identifier that does not reveal a patient's identity, and a prescribed drug;
wherein each medical claim includes information representing a unique patient identifier that does not reveal the patient's identity, and at least one indication;
linking the medical claims submitted by the identified practitioners to the longitudinal prescription scripts at least in part based on a matching unique patient identifier that does not reveal the patient's identity;
based on each linked medical claim and longitudinal prescription script, generating a record of using the prescription drug for the corresponding one or more indication by the matching practitioner outside the non-retail facility;
generating a distribution factor of using the prescription drug for each of the one or more indications by the identified practitioners outside the non-retail facility;
receiving information showing a volume of the prescription drug sold to the non-retail facility; and
generating usage data for each of the one or more indications of the prescription drug for the non-retail facility by applying the generated distribution factor of using the prescription drug for each of the indications by the identified physicians outside the non-retail facility to the received information showing the volume of the prescription drug sold to the non-retail facility.
